(19) United States
(12) Patent Application Publication
(10) Pub. No.: US 2014/0346206 A1
(43) Pub. Date: Nov. 27, 2014

(54) FISHING ROD TRANSPORTER

(71) Applicants: Scott McKnight, Jacksonville, FL (US); David McKnight, Jacksonville, FL (US)

(72) Inventors: Scott McKnight, Jacksonville, FL (US); David McKnight, Jacksonville, FL (US)

(21) Appl. No.: 14/457,057

(22) Filed: Aug. 11, 2014

Related U.S. Application Data
(63) Continuation-in-part of application No. 12/693,555, filed on Jan. 26, 2010, now abandoned.

(51) Int. Cl. A47B 81/00; E05B 73/00; B60R 7/08

(52) U.S. Cl. CPC A47B 81/005; B60R 7/08; E05B 73/00
USPC 224/404

(57) ABSTRACT

A fishing rod transporter includes a hollow tubular holder coupled to an adjustable length bar. The adjustable length bar is linearly extendible by ratcheting action to securely fit between sidewalls of a bed of a pickup truck. A hollow holder defines a compartment for receiving a handle-end of a fishing rod. Slots formed in the peripheral wall of the top end of the hollow holder define a limited space for receiving a neck of a fishing reel.

### RELATED APPLICATIONS

This application is a continuation in part and claims the benefit of priority of U.S. Nonprovisional application Ser. No. 12/693,555, filed Jan. 26, 2010, the entire contents of which are incorporated herein and made a part hereof by this reference.

### FIELD OF THE INVENTION

This invention relates generally to fishing rods, and, more particularly, to transporter configured to support and secure fishing rods off of a floor, between adjacent walls of a vehicle, such as the side walls of a pickup bed, without drilling into or otherwise damaging the walls.

### BACKGROUND

Fishing rods and reels can be extremely expensive and easily damaged or stolen. When stored loosely on the floor of a moving vehicle (e.g., the bed of a truck), rods and reels can be damaged from sliding and impacting (or being impacted by) other objects including vehicular structures and other loose items. Such storage also risks tangling of lines and gear, which can be tedious or impossible to undo. When stored in the bed of a pickup truck, closing the tailgate may also damage rods and reels.

Another serious problem is risk of theft. Expensive rods and reels are very tempting to thieves. Leaving such items unattended in an accessible area, such as the bed of a pickup truck, even for a brief moment, invites loss due to theft.

Over the years, various rod and reel holders have been devised. While they generally constitute improvements over having no holder, the known prior art holders arguably have shortcomings. Many do not keep rods and reels off the floor. Instead they secure the items to the floor, where they can be damaged from other loose items. Additionally, many requiring drilling or other forms of permanent fastening. Not only are such devices inconvenient to move and install on a new vehicle, but they tend to comprise the integrity of the finish of the vehicle, which may lead to corrosion. Furthermore, many such devices can accommodate only limited length rods, because of limitations of the holder or the manner in which it holds the rods. Moreover, many prior art holders offer little or nothing in the way of optional security accessories to guard against theft.

As an example of a prior rod holder that is not suitable for truck bed use, Hall, U.S. Pat. No. 3,524,572,describes a roof-mounted pole carrier with a pair of spaced apart parallel holders, i.e., a forward holder and a rear holder. Each holder extends across the roof, from the passenger to driver's side of the roof. Each holder has a tubular portion slidably mounted thereon. The tubular portions are configured with brackets and to engage ends of the fishing poles. The holders are fixed to the roof using hinge-type brackets. Hall's brackets 42 are screwed to the roof. While Hall's holder is extendible in width, it is not configured to exert pressure between sidewalls of a truck bed. Hall contemplates only roof mounting using screwed brackets. Hall's telescoping components are set according to defined hole positions with mating spring biased button. Such a configuration defines a limited number of positions, which are well suited for Hall's roof mount but would be entirely unsuitable for exerting sufficient pressure against sidewalls of a truck bed for mounting. Nothing in Hall teaches or suggests otherwise. Hall does not teach a holder for the bed of a truck, much less a horizontal support comprising a plurality of telescopically adjustable sections and a linear ratcheting mechanism with an actuator configured to controllably linearly urge one telescopically adjustable section outwardly from another telescopically adjustable section.

While Liberto, U.S. Pat. No. 5,813,164, describes a tubular holder for transporting fishing rods in the bed of a truck, the tubular holder includes mounting members that must fit into the hole of a vehicle bed side wall. Not all pickup trucks have such holes in vehicle sidewalls. While such holes can be formed, many truck owners resist such modifications to their truck bed. Thus, Liberto does not teach a holder securable between the sidewalls of a truck bed by pressure, much less a horizontal support comprising a plurality of telescopically adjustable sections and a ratcheting mechanism with an actuator configured to controllably linearly urge one telescopically adjustable section outwardly from another telescopically adjustable section. Additionally, Liberto does not teach or suggest a clamp attached to the annular collar, said clamp being configured to releasably secure the hollow holder to the adjustable length horizontal support, said clamp defining an opening through which the adjustable length horizontal support is received perpendicular to the hollow holder, and said hollow holder being horizontally movable by sliding the clamp along the adjustable length horizontal support.

Delancey, U.S. Pat. No. 5,054,737 describes a fishing rod holder with a base adapted for mounting on a vertical or horizontal surface, a fishing rod receptacle, and an articulated support member. The articulated support member includes joints for pivoting about orthogonal axes. In one embodiment, a ratchet mechanism controls pivoting rotation, only pivoting rotation, of the articulated support mechanism. Thus, the ratchet allows the joint to be locked at a certain angle. The ratchet does not enable elongation. It only enables pivoting motion. Delancey's ratchet only controls pivoting motion, not movement of one part outward from another. This is plainly evident in FIGS. 5 and 9 of Delancey. Delancey explains the purpose and function of the ratchet as a means for limiting pivoting rotation: “ratchet and pawl mechanism . . . to block pivotal movement” [col. 2, lines 15-18] “coacting ratchet and pawl means . . . to block pivotal movement of said receptacle in one direction” [col. 4, lines 57-60]. Angularly adjustable holders, such as those taught in Delancey, are useful for mounting on a horizontal or vertical surface of a boat to hold a rod for fishing. However, such a holder cannot be used to support a plurality of rods, or, for that matter, any rod by exerting pressure between the sidewalls of a bed of a truck.

Deloza, U.S. Pat. No. 6,019,265 describes a snowboard rack with a horizontal support, referred to as a header shaft, having telescoping sections urged by springs towards opposite sidewalls of a truck bed. Pressure exerted against the sidewalls is defined only by the springs. For Deloza's snowboard rack which lays on the floor of the truck bed, the risk of loosening is not catastrophic. The snowboard will remain in the bed of the truck, even if the springs exert insufficient force. However, such a product is not suitable for securing fishing rods in an elevated position (e.g., rods in angled positions with one end extending far above the truck bed) in the bed of a truck. Additionally, the range of adjustment is greatly limited by the spring size and spring constant. The holding pressure is a function of the extent of compression of the spring, with a wide truck bed receiving less pressure than a narrow truck bed. Again, such a configuration is of limited utility for a truck bed rod holder.

The invention is directed to overcoming one or more of the problems and solving one or more of the needs as set forth above.

### SUMMARY OF THE INVENTION

To solve one or more of the problems set forth above, in an exemplary implementation of the invention, a fishing rod transporter, according to principles of the invention, includes a hollow holder coupled to an adjustable length horizontal support. The hollow holder defines a compartment for receiving a handle-end of a fishing rod. An opposite end of the fishing rod extends outwardly from the hollow holder. The hollow holder has a top end, a bottom end and a peripheral wall, and a first slot formed in the peripheral wall of the top end of the hollow holder defining a limited space for receiving a neck of a fishing reel. The adjustable length horizontal support being linearly extendible to securely fit between sidewalls of a bed of a pickup truck and secure the adjustable length horizontal support to the bed of the pickup truck by applying pressure between the sidewalls of the bed of the pickup truck without any means for penetrating the sidewalls of the pickup truck. The adjustable length horizontal support includes a plurality of telescopically adjustable sections, including a first section and a second section, and a ratcheting mechanism with an actuator controllably linearly urging the first section outwardly from the second section. The ratcheting mechanism includes a linear rack on (formed on or attached to) the first section, with an engaging finger operably coupled to the actuator operably coupled to the second section and a pivoting pawl operably coupled to the second section and controllably engaging the linear rack on the first section. A spring urges the pawl into an engaged position, the pawl engaging the linear rack on the first section in the engaged position. A pawl release is provided to disengage the pawl from the linear rack and allow retraction of the first section of the telescopically adjustable sections into the second section of the telescopically adjustable sections. Another spring urges the finger into an engaged position. A lock disables the actuator and pawl release, thereby preventing or resisting removal of the adjustable length horizontal support unless it is unlocked. The adjustable length horizontal support includes a first end and an opposite second end, a first gripping pad attached to the first end and a second gripping pad attached to the second end. The first and second gripping pads exert pressure against the sidewalls of the pickup truck, the exerted pressure secures the adjustable length horizontal support to the bed of the pickup truck. An annular collar surrounds a portion of the peripheral wall of the hollow holder and is movable along the length of the hollow holder. A fastener locks the annular collar in place on the hollow holder. A clamp attached to the annular collar releasably secures the hollow holder to the adjustable length horizontal support and defines an opening through which the adjustable length horizontal support is received perpendicular to the hollow holder. The hollow holder is horizontally movable by sliding the clamp along the adjustable length horizontal support when the first and second gripping pads exert pressure against the sidewalls of the pickup truck to secure the adjustable length horizontal support to the bed of the pickup truck.

A portion of the peripheral wall adjacent to the first slot conceals attachment elements for coupling the fishing reel to the fishing rod. Optionally a protective cover is attached to the bottom end of the hollow holder. The protective cover may include at least one hole for drainage.

The hollow holder may be a tubular body.

The hollow holder may optionally include a second slot formed in the peripheral wall of the top end of the hollow holder opposite the first slot. Such a second slot defines a limited space for receiving the neck of the fishing reel.

A fastener for locking the annular collar in place on the hollow holder may be a set screw.

In another exemplary embodiment, a fishing rod transporter according to principles of the invention includes a hollow holder coupled to an adjustable length bar, the hollow holder defining a compartment for receiving a handle-end of a fishing rod, the hollow holder having a top end, a bottom end and a peripheral wall, a first slot formed in the peripheral wall of the top end of the hollow holder, the slot defining a limited space for receiving a neck of a fishing reel, and the adjustable length bar is extendible to securely fit between sidewalls of a bed of a pickup truck. The first slot concealing attachment elements for coupling the fishing reel to the fishing rod. The hollow holder is a tubular body. The hollow holder further includes a second slot formed in the peripheral wall of the top end of the hollow holder opposite the first slot, the second slot defining a limited space for receiving a neck of a fishing reel, and the adjustable length bar is extendible to securely fit between sidewalls of a bed of a pickup truck.

A clamp is attached to the hollow holder the clamp is configured to secure the holder to the adjustable length bar. The clamp may be removable and adjustable. The clamp may be attached to a collar that is movable along the hollow holder and locked into place using a set screw.

Optionally, a lock assembly may engage the top of the hollow holder. The lock assembly engages the top of the hollow holder, and secures a rod and reel in the hollow holder. The lock assembly includes a cap with a top opening configured to allow a rod to extend therethrough. The cap also includes a lock opening. The hollow holder includes a locking device extending from the top end. The locking device is configured to extend through the lock opening and is engageable by a lock or a cable and lock assembly. When locked, the cap prevents removal of the rod and reel by blocking release of the reel neck from the first slot.

The adjustable length bar includes a plurality of telescopically adjustable sections and a ratcheting mechanism with an actuator configured to controllably drive one section outwardly from another section. A release is provided to release the ratchet and allow retraction of the driven section. Optionally, a lock disables the actuator and/or release, thereby preventing or resisting removal of the bar assembly unless it is unlocked. A pair of gripping pads attached at opposite ends of the adjustable length bar.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a side view of an exemplary tubular holder of a fishing rod transporter according to principles of the invention; and

FIG. 2 is a perspective view of an exemplary tubular holder of a fishing rod transporter according to principles of the invention; and

FIG. 3 is an exploded perspective view of an exemplary tubular holder of a fishing rod transporter according to principles of the invention; and

FIG. 4 is a perspective view of an exemplary tubular holder of a fishing rod transporter holding a rod according to principles of the invention; and

FIG. 5 is a side view of an exemplary adjustable length bar for a fishing rod transporter according to principles of the invention; and

FIG. 6 is a perspective view of an exemplary fishing rod transporter assembly comprising the adjustable length bar and a plurality of tubular holders coupled to the bar according to principles of the invention; and

FIG. 6A is a side view of an exemplary fishing rod transporter assembly comprising the adjustable length bar and a plurality of tubular holders coupled to the bar according to principles of the invention, with a wall of a pickup bed removed;

FIG. 7 is a first perspective view of an exemplary truck with the exemplary fishing rod transporter assembly according to principles of the invention; and

FIG. 8 is a first perspective view of an exemplary truck with the exemplary fishing rod transporter assembly according to principles of the invention; and

FIG. 9 is a high level schematic of one exemplary ratcheting mechanism for a exemplary fishing rod transporter assembly according to principles of the invention.

Those skilled in the art will appreciate that the figures are non-limiting and not intended to be drawn to any particular scale; nor are the figures intended to illustrate every embodiment of the invention. The invention is not limited to the exemplary embodiments depicted in the figures or the types of clamps, locks, adjustment mechanisms, handle configurations, fishing equipment, vehicles, shapes, relative sizes, ornamental aspects or proportions shown in the figures.

### DETAILED DESCRIPTION

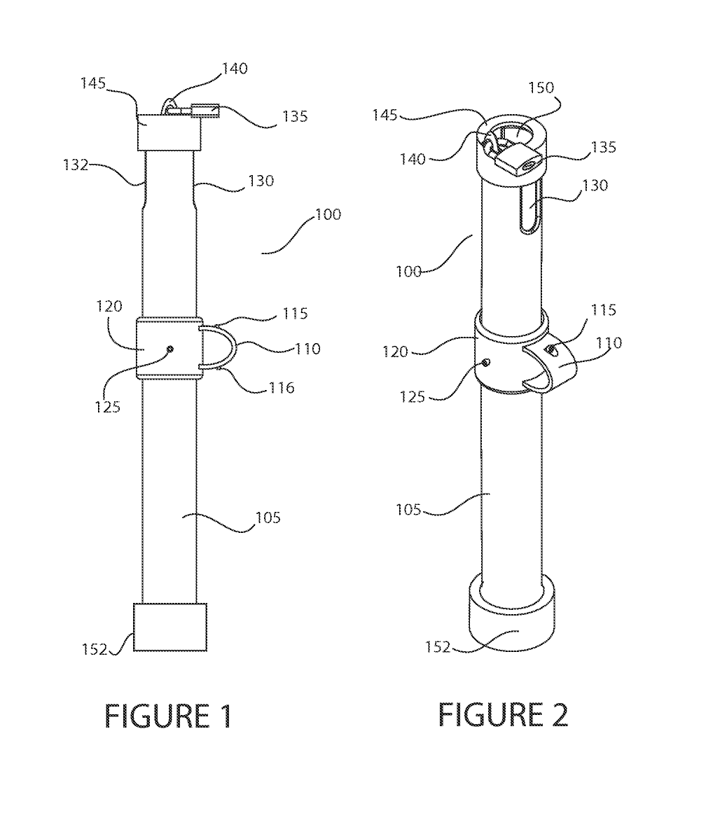

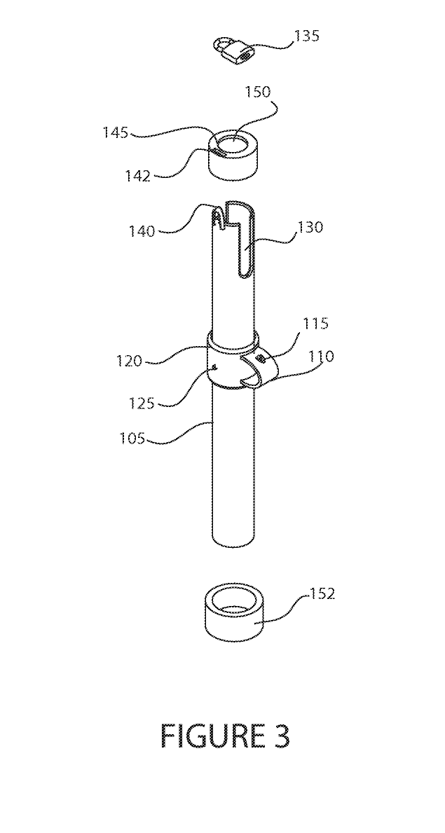

As shown in FIGS. 1 through 3, an exemplary tubular (i.e., hollow) holder 100 of a fishing rod transporter according to principles of the invention includes a tubular body 105. While the term tubular is used herein, the cross section is not limited to any particular shape, circular or otherwise. The tubular body 105 provides a compartment for receiving the handle-end of a fishing rod. One or more slots 130, 132 at the top end of the tubular body 105 are provided to receive the neck of a reel assembly. The slots may be sized to receive the neck but conceal elements attaching the reel to the rod, such that the reel cannot be removed from the rod while contained in the holder 100.

In one embodiment, a clamp 110 is attached to the tubular body 105. The clamp 110 is configured to secure the holder 100 to an adjustable length bar. The clamp 100 may be adjustable or fixed, removable or permanently attached. In a preferred embodiment, the clamp 100 is removable and adjustable to facilitate coupling to the bar. Thus, for example, the clamp 100 may be removably attached using fasteners such as screws 115, 166. The clamp 100 may also be attached to a collar 120, that may be moved (i.e., slid) along the length of the tubular body 105 and locked into place using a locking means such as a set screw 125. In another embodiment, another type of mechanism for clamping the bar may be used. Such mechanisms include, without limitation, a band clamp or web clamp; bar clamp, F-clamp or sliding clamp; Cardellini clamp; C-clamp (or G-clamp); a Kant-Twist clamp; pipe clamp; hose clamp or Marman clamp. In yet another embodiment, the tubular body 105 is permanently secured to the bra by welding or bonding. In still another embodiment the tubular body may be secured to the bar using screws or nuts and bolts.

Optionally, a lock assembly is provided for engaging the top of the tubular body. The lock assembly secures a rod and reel in the tubular body 105. An exemplary lock assembly comprises a cap 145 with a top opening 150 configured to allow a rod to extend therethrough. The cap 145 also includes a lock opening 142 through which a locking device, such as an eyelet or C-shaped member 140 extends. A padlock or similar lock 135 may then be secured to the exposed locking member 140 extending through the corresponding opening 142 in the cap 145. When locked in place, the cap 145 prevents removal of the rod and reel by blocking release of the reel neck from the slot 130, 132.

Alternatively, a cable with loops at its ends, may run through the locking member 140 of each adjacent tubular holder. Then the loops may be joined with a padlock, or be independently locked with a padlock. Such an embodiment allows unlocking of one lock to remove any and all secured rods and reels.

An optional cushion 152 is provided to protect the bottom end of the tubular body 105. The cushion 152 comprises a rubber, silicone, another durable elastomer or a foam polymer (e.g., Neoprene®) sleeve that fits over the bottom end of the tubular body 105. The bottom end of the tubular body 105 and the cushion are perforated to allow drainage of water caught in the tubular body 105. The cushion 152 helps protect the floor and wall of the truck bed from damage and dampens any noise generated by contact between the bottom end of the tubular body 105 and truck bed.

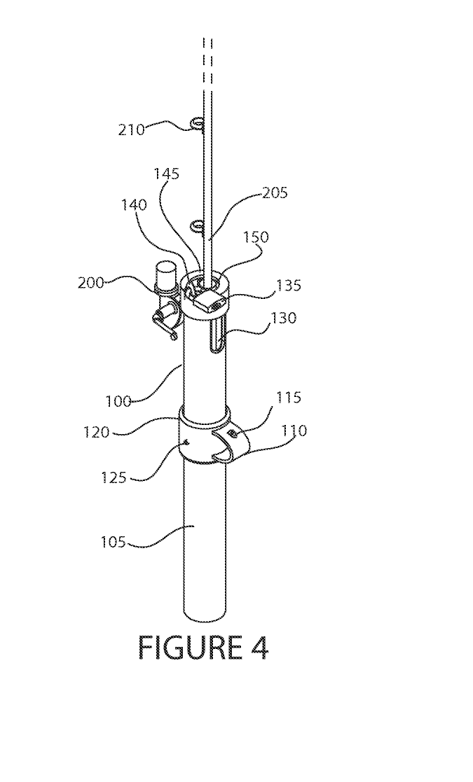

Referring now to FIG. 4, a perspective view of an exemplary tubular holder of a fishing rod transporter holding a rod according to principles of the invention is provided. The reel assembly 200 extends through the slot 132, via the neck of the reel. The rod 205 and eyelets 210 with any line and terminal tackle, extend through the top opening 150 in the locking cap 145. The lock member 140 engaged by the padlock 135, prevents removal of the cap 145, which prevents release of the neck of the reel 200 extending through the slot 132.

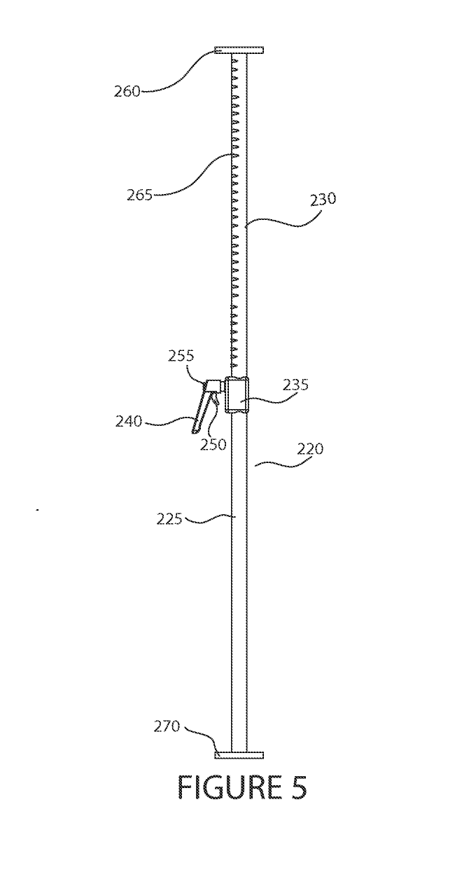

Referring now to FIG. 5, a side view of an exemplary adjustable length bar assembly 220 or a fishing rod transporter according to principles of the invention is shown. The bar includes a plurality of adjustable sections 225, 230. By way of example and not limitation, section 225 may be tubular and section 230 may have a slightly smaller outer diameter than the inner diameter of the first section 225. Thus, section 230 may extend telescopically from section 225.

Extension may be effectuated mechanically, hydraulically or pneumatically. Illustratively, a ratcheting mechanism 235 with a handle actuator 240 may drive the second section 235 by engaging notches 265 in the second section and urging the second section outwardly from the first section 225. A release 250 may be provided to release the ratchet and allow retraction of the second section 230. A lock 255 may also be provided to disable the actuator and/or release, thereby preventing or resisting removal of the bar assembly unless it is unlocked. Alternatively, the second section 230 may include a threaded portion, threadedly engaged by a corresponding portion of the first section 225. In such case, turning the second section 230 relative to the first causes extension or retraction, depending upon the direction. As another alternative, telescopic tubes with locking pins and a padlock may be used to secure the bar in any one of a number of positions. A ratcheting or threaded assembly that provides infinite (i.e., continuous) or near-infinite (small increment) adjustment is preferred for convenience, reliability and cost effectiveness.

A pair of gripping pads 260, 270 are provided at opposite ends of the bar assembly 220. The pads 260, 270 engage walls, between which the bar assembly is frictionally secured. The pads may be articulating, pivoting, adjustable and removable or permanently fixed. As the bar assembly 220 is lengthened, the pads exert pressure against the walls. Frictional engagement prevents the bar assembly from moving. The pads may be comprised of a rigid body coated or covered with a rubber, plastic or other material that is relatively soft but features a relatively high coefficient of friction. The softness prevents damage to the vehicle finish. The friction helps secure the bar assembly 220 in place. In a pivoting or swiveling embodiment, a pivot or ball joint connects the pad to the bar. This allows adjustment to accommodate irregular wall surfaces and misalignment.

Advantageously, the adjustable length bar assembly is extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck. Thus, no screws are needed to secure the bar to the bed. No drilling or penetration is necessary to secure the bar to the bed. This avoids damage to the truck bed.

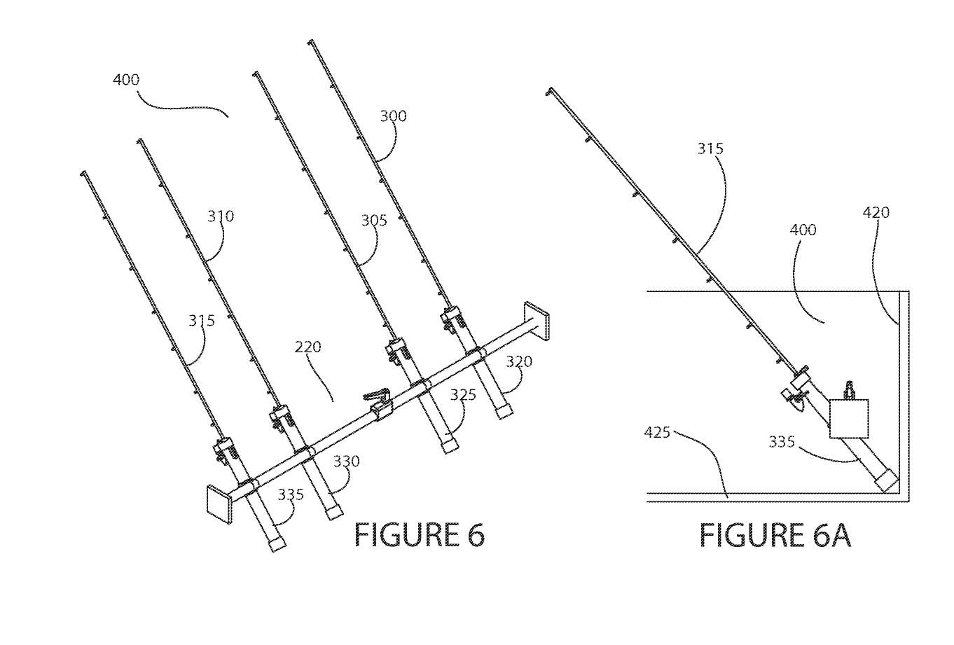

Referring now to FIG. 6, a perspective view of an exemplary fishing rod transporter assembly comprising the adjustable length bar assembly 220 and a plurality of tubular holders 320-335 coupled to the bar assembly 220 using corresponding clamps, according to principles of the invention is shown. A real and rod 300-315 is secured in each holder 320-335 for safe and secure transport. The bar assembly 220 is extendable to securely fit between parallel walls, such as the side walls of a truck bed.

FIG. 6A provides a side view of the system installed in a cutaway view of a truck bed. The pads 260, 270 of the bar are pressed firmly against sidewalls 400, 415 of the truck bed. The tubular holders 320-335 are angled and positioned such that the bottom ends of the tubular holders 320-335 are wedged between the front wall 420 of the truck bed and the floor 425 of the truck bed. This is the preferred configuration for transporting rods and reels in a truck bed in accordance with the invention.

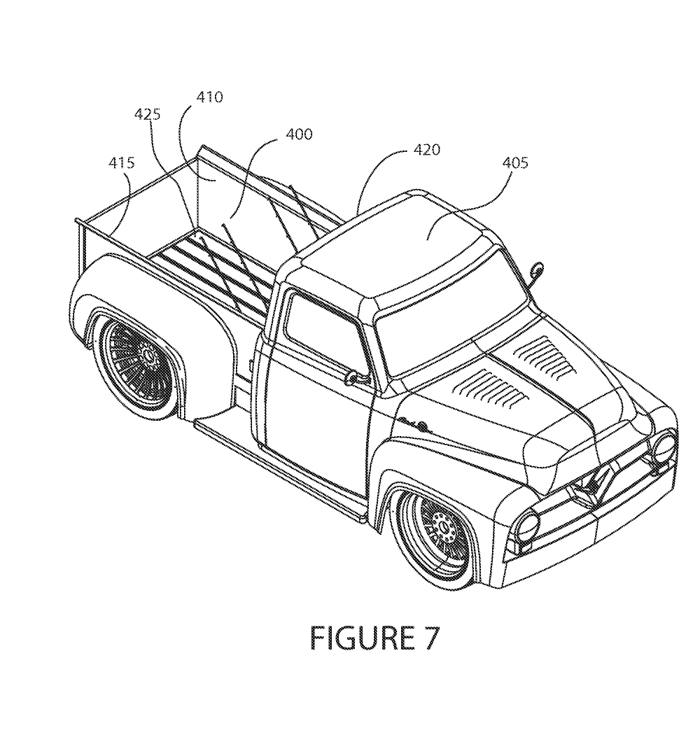

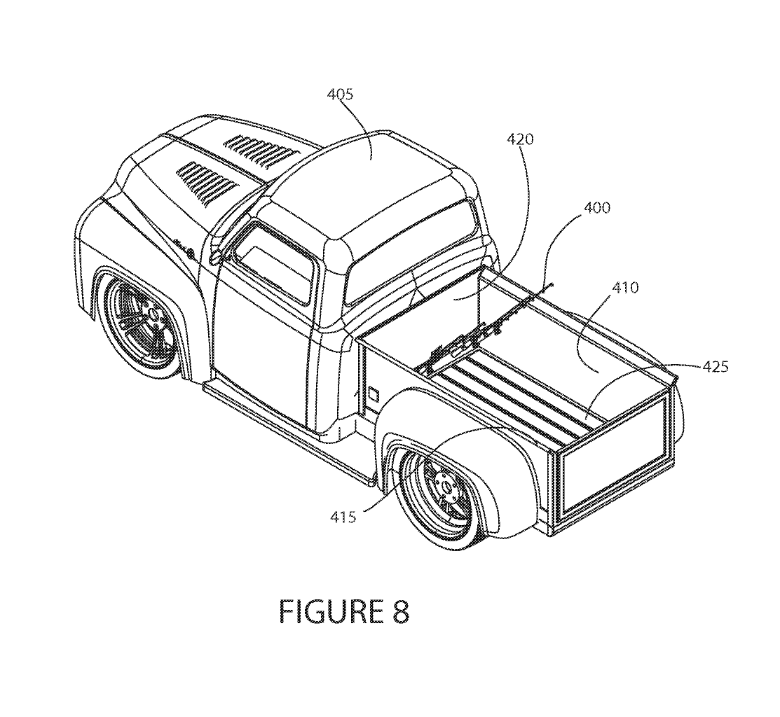

FIGS. 7 and 8 provide perspective views of an exemplary truck 405 with an exemplary fishing rod transporter assembly 400 according to principles of the invention. The holders and rods with reels 300-315 are angled from the lower portion of the front wall 420 of the bed and the bar assembly 220. Preferably, the bar assembly 220 is positioned to secure the holders in the corner defined by the floor and front wall of the bed. The bar assembly 220 is held in place between the side walls 410, 415 of the bed.

The tubular holder 100 may be comprised of any material that exhibits sufficient rigidity and strength to support fishing equipment during transport. By way of example and not limitation, the tubular holder 100 may be comprised of wood or metal such as steel, stainless steel, aluminum, an alloy or some other metal, which may be coated (e.g., anodized and/or painted or powder coated or resin coated) to resist corrosion, to prevent damage to the rod and reel, and to maintain good aesthetics.

Alternatively, the tubular holder 100 may be fabricated using plastic by any suitable plastic forming technique. For example, the tubular holder 100 may be comprised of a plastic or polymeric material, such as polyvinyl chloride (PVC), nylon, polysulfone, polyethylene, polypropylene, polystyrene, acrylics, cellulosics, acrylonitrile-butadiene-styrene (ABS) terpolymers, urethanes, thermo-plastic resins, thermo-plastic elastomers (TPE), acetal resins, polyamides, polycarbonates and/or polyesters. Other suitable polymeric compositions are known to those familiar with the art and may also be used in accordance with the present invention. Preferably the chosen material is relatively inexpensive, produces a rigid, durable and strong product, is easy to use in manufacturing operations and results in an aesthetically acceptable product.

The material may further include additives to provide desired properties such as desired colors, structural characteristics, glow-in-the dark properties and thermal reactivity (e.g., color changes according to heat). Illustratively, phosphorescent polymer additives, such as aluminate based phosphors, may be added to adsorb light energy and continue to release that energy as visible light, after the energy source is removed. Advantageously, such an embodiment provides a glow-in-the-dark holder that is easy to locate at night.

The tubular holder 100 may be produced using any suitable manufacturing techniques known in the art for the chosen material, such as (for example) injection, compression, structural foam, blow, or transfer molding; polyurethane foam processing techniques; vacuum forming; casting; milling; and extrusion. Preferably the manufacturing technique is suitable for mass production at relatively low cost per unit, and results in an aesthetically acceptable product with a consistent acceptable quality and structural characteristics.

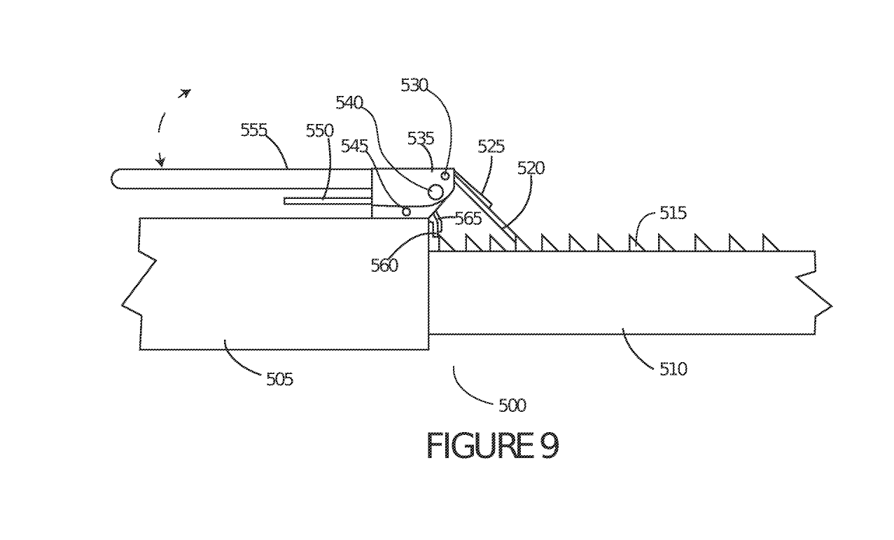

FIG. 9 provides a schematic of an exemplary linear actuator for a holder according to principles of the invention. The exemplary linear actuator is a linear ratcheting mechanism 500. The linear ratcheting mechanism 500 includes telescoping hollow poles 505, 510, one of which 510 fits within the other 505 and is slidably extendable therefrom. The narrower pole 510 includes a linear rack 515. The rack 515 includes a plurality of teeth or notches that are engageable by a pawl 560 and a finger 520. Springs 525 and 565 urge the finger 520 and pawl 560 in the engaged position. The finger 520 is pivotally coupled to coupled to a pivoting yoke 535. The yoke pivots about barrel 540 that is coupled to pole 505. The finger 520 pivots about pin 530. The spring 525 restrains movement of the finger away from the rack 515, urging the finger towards the notches or teeth of the rack 515. Lever 555 is operably coupled to and controls the pivoting of finger 520. Pivoting motion of the handle 555 cause pivoting motion of the finger 520 which pushes against a tooth of the rack 515, slides over the top of the next tooth and then pushes against that tooth when as the handle 555 comes to the at rest position. In this manner, the ratcheting mechanism advances the inner pole 510 tooth by tooth. When the teeth of the rack 555 are moving in the unrestricted (i.e., expanding) direction, the pawl 560 easily slides up and over the gently sloped edges of the teeth, with a spring forcing it into the depression between the teeth as it passes the tip of each tooth. When the teeth move in the opposite (i.e., collapsing) direction, however, the pawl 560 will catch against the steeply sloped edge of the first tooth it encounters, thereby locking it against the tooth and preventing any further motion in that direction. A lever 550 mechanically coupled to the pawl allows a user to release the pawl 560 by pressing the lever. When released, the pawl 560 pivots away from the teeth so that the rack 555 may move unimpeded relative to the pawl 560. To urge the rack 550 in the expanding direction, the lever 555 is raised (i.e., pivoted away from the pole 505), the finger 520 engages and pushes against a tooth of the rack, depending upon the angular extent to which the actuating ratchet lever was initially raised. This pushing advances the rack 555 and attached pole 510 in the expanding direction. As the actuating lever 555 is moved downwardly, finger 520 pivots towards another tooth of the rack 555. All the while, the pawl 560 prevents collapsing (i.e., retracting) motion of the poles unless the pawl release lever 550 is actuated. In this manner, the pole is controllably longitudinally expanded, and allowed to retract.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A fishing rod transporter comprising
a hollow holder coupled to an adjustable length horizontal support, said hollow holder defining a compartment for receiving a handle-end of a fishing rod, an opposite end of the fishing rod extending outwardly from the hollow holder, said hollow holder having a top end, a bottom end and a peripheral wall, including a peripheral wall of the top end of the hollow holder, a first slot formed in the peripheral wall of the top end of the hollow holder, said first slot defining a limited space for receiving a neck of a fishing reel, and
said adjustable length horizontal support being linearly extendible to securely fit between sidewalls of a bed of a pickup truck and secure the adjustable length horizontal support to the bed of the pickup truck by applying pressure between the sidewalls of the bed of the pickup truck without any means for penetrating the sidewalls of the pickup truck, said adjustable length horizontal support comprising a plurality of telescopically adjustable sections, including a first section and a second section, and a ratcheting mechanism with an actuator controllably linearly urging the first section outwardly from the second section,
said ratcheting mechanism comprising a linear rack on the first section with an engaging finger operably coupled to the actuator operably coupled to the second section and a pivoting pawl operably coupled to the second section and controllably engaging the linear rack on the first section; and
said adjustable length horizontal support including a first end and an opposite second end, a first gripping pad attached to said first end and a second gripping pad attached to said second end, said first and second gripping pads exerting pressure against the sidewalls of the pickup truck, said exerted pressure securing the adjustable length horizontal support to the bed of the pickup truck; and
an annular collar surrounding a portion of the peripheral wall of the hollow holder and movable along the length of the hollow holder, a fastener for locking the annular collar in place on the hollow holder, and a clamp attached to the annular collar, said clamp being configured to releasably secure the hollow holder to the adjustable length horizontal support, said clamp defining an opening through which the adjustable length horizontal support is received perpendicular to the hollow holder, and said hollow holder being horizontally movable by sliding the clamp along the adjustable length horizontal support when said first and second gripping pads exert pressure against the sidewalls of the pickup truck to secure the adjustable length horizontal support to the bed of the pickup truck.

2. The fishing rod transporter according to claim 1, further comprising a spring urging the pawl into an engaged position, said pawl engaging the linear rack on the first section in the engaged position.

3. The fishing rod transporter according to claim 1, further comprising a spring urging the finger into an engaged position, said finger engaging the linear rack on the first section in the engaged position.

4. The fishing rod transporter according to claim 2, further comprising a spring urging the finger into an engaged position, said finger engaging the linear rack on the first section in the engaged position.

5. The fishing rod transporter according to claim 1, a portion of the peripheral wall adjacent to the first slot concealing attachment elements for coupling the fishing reel to the fishing rod; and
further comprising a protective cover attached to the bottom end of the hollow holder, said protective cover including at least one hole for drainage.

6. The fishing rod transporter according to claim 5, said hollow holder being a tubular body.

7. The fishing rod transporter according to claim 6, said hollow holder further comprising a second slot formed in the peripheral wall of the top end of the hollow holder opposite the first slot, said second slot defining a limited space for receiving the neck of the fishing reel.

8. The fishing rod transporter according to claim 7, said fastener for locking the annular collar in place on the hollow holder being a set screw.

9. The fishing rod transporter according to claim 4, a portion of the peripheral wall adjacent to the first slot concealing attachment elements for coupling the fishing reel to the fishing rod; and
further comprising a protective cover attached to the bottom end of the hollow holder, said protective cover including at least one hole for drainage.

10. The fishing rod transporter according to claim 9, said hollow holder being a tubular body.

11. The fishing rod transporter according to claim 10, said hollow holder further comprising a second slot formed in the peripheral wall of the top end of the hollow holder opposite the first slot, said second slot defining a limited space for receiving the neck of the fishing reel.

12. The fishing rod transporter according to claim 11, said fastener for locking the annular collar in place on the hollow holder being a set screw.

13. The fishing rod transporter according to claim 1, further comprising a release to disengage the pawl from the linear rack and allow retraction of the first section of the telescopically adjustable sections into the second section of the telescopically adjustable sections.

14. The fishing rod transporter according to claim 13, further comprising a lock configured to disable the actuator and release, thereby resisting removal of the adjustable length horizontal support unless it is unlocked.

15. The fishing rod transporter according to claim 13, further comprising a lock configured to disable the actuator and release, thereby preventing removal of the adjustable length horizontal support unless it is unlocked.

16. The fishing rod transporter according to claim 12, further comprising a release to disengage the pawl from the linear rack and allow retraction of the first section of the telescopically adjustable sections into the second section of the telescopically adjustable sections.

17. The fishing rod transporter according to claim 16, further comprising a lock configured to disable the actuator and release, thereby resisting removal of the adjustable length horizontal support unless it is unlocked.

18. A fishing rod transporter comprising a hollow holder coupled to an adjustable length bar, said hollow holder defining a compartment for receiving a handle-end of a fishing rod, said hollow holder having a top end, a bottom end and a peripheral wall, a first slot formed in the peripheral wall of the top end of the hollow holder, said slot defining a limited space for receiving a neck of a fishing reel, and said adjustable length bar being extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck; and
said first slot concealing attachment elements for coupling the fishing reel to the fishing rod;
said hollow holder being a tubular body;
said hollow holder further comprising a second slot formed in the peripheral wall of the top end of the hollow holder opposite the first slot, said second slot defining a limited space for receiving a neck of a fishing reel, and said adjustable length bar being extendible to securely fit between sidewalls of a bed of a pickup truck and secure the adjustable length bar to the bed of the pickup truck by applying pressure between the sidewalls of the bed of the pickup truck without any means for penetrating the sidewalls of the pickup truck.

19. The fishing rod transporter according to claim 18, further comprising a clamp attached to the hollow holder, said clamp being configured to secure the holder to the adjustable length bar, said clamp being removable and adjustable in position, and said clamp being attached to a collar that is movable along the hollow holder and locked into place using a set screw.

20. A fishing rod transporter according to claim 19 further comprising a lock assembly engaging the top of the hollow holder, said lock assembly securing a rod and reel in the hollow holder, said lock assembly comprising a cap with a top opening configured to allow a rod to extend there through, said cap including a lock opening, and said hollow holder including a locking device extending from the top end, and said locking device extending through the lock opening and being engageable by a padlock, said cap preventing removal of the rod and reel by blocking release of the reel neck from the first slot.
